(19) United States
(12) Patent Application Publication
(10) Pub. No.: US 2010/0123794 A1
(43) Pub. Date: May 20, 2010

(54) SYSTEM AND METHOD FOR CAPTURING AND REPRODUCING AN IMAGE OPTIMIZED FOR CHARACTERISTICS OF A REPRODUCING APPARATUS

(75) Inventors: Young-soo Bok, Suwon-si (KR); Jae-hyo Jung, Suwon-si (KR); Hyun-seok Kim, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/615,435

(22) Filed: Nov. 10, 2009

(30) Foreign Application Priority Data
Nov. 18, 2008 (KR) 10-2008-0114861

(51) Int. Cl. H04N 9/73; H04N 5/222; H04N 5/217; H04N 5/202

(52) U.S. Cl. 348/223.1; 348/333.01; 348/241; 348/254; 348/E05.022; 348/E05.074

(57) ABSTRACT

A system for capturing and reproducing an image may include a digital image processor which captures an image, acquires characteristics of a reproducing apparatus, processes the captured image according to the characteristics of the reproducing apparatus to obtain an optimal image, and transmits the optimal image to the reproducing apparatus. The system may also include the reproducing apparatus which may then display the optimal image and a connection unit which transmits and receives data including the characteristics of the reproducing apparatus and the optimal image between the digital image processor and the reproducing apparatus.

### CROSS-REFERENCE TO RELATED PATENT APPLICATION

This application claims the priority benefit of Korean Patent Application No. 10-2008-0114861, filed on Nov. 18, 2008, in the Korean Intellectual Property Office, the disclosure of which is incorporated herein in its entirety by reference.

### BACKGROUND

1. Field of the Invention

The present invention generally relates to a system and method for capturing and reproducing an image, and more particularly to a system and method for capturing and reproducing an image optimized for characteristics of a reproducing apparatus.

2. Description of the Related Art

Typically, a digital image processor may allow a user to confirm a captured image via an embedded display unit, such as a liquid crystal display (LCD), or via an external reproducing apparatus such as a monitor, an LCD, a cathode ray tube (CRT), a projector, or a printer. In the case of an external reproducing apparatus, the digital image processor typically transmits the captured image to the reproducing apparatus without any special processing and the reproducing apparatus displays the captured image.

However, according to the unique characteristics of the reproducing apparatus, e.g., the type or manufacturer thereof, the noise, color, and brightness of the captured image typically varies when the captured image is displayed. The captured image may be displayed as an optimal image by some certain reproducing apparatuses, but may not be displayed as an optimal image by other reproducing apparatuses. When the captured image is not displayed as an optimal image by the other reproducing apparatuses, the captured image may be displayed, for example, with much noise and blue color, or many dark tones.

### SUMMARY

A system for capturing and reproducing an image may include a digital image processor which captures an image, acquires characteristics of a reproducing apparatus, processes the captured image according to the characteristics of the reproducing apparatus to obtain an optimal image, and transmits the optimal image to the reproducing apparatus. The system may also include the reproducing apparatus which may then display the optimal image and a connection unit which transmits and receives data including the characteristics of the reproducing apparatus and the optimal image between the digital image processor and the reproducing apparatus.

A system for capturing and reproducing an image may include a digital image processor for capturing an image, a reproducing apparatus for reproducing the image captured by the digital image processor, and a connection unit for transmitting and receiving data between the digital image processor and the reproducing apparatus. The digital image processor may process the image captured by the digital image processor according to characteristics information of the reproducing apparatus to obtain an optimal image and transmit the optimal image to the reproducing apparatus.

The digital image processor may include a database for storing characteristics information of a variety of reproducing apparatuses and image processing setting values corresponding to the characteristics information of the variety of reproducing apparatuses. The digital image processor may also include a characteristics information acquiring unit for acquiring the characteristics information of the reproducing apparatus from the database. The digital image processor may further include an image processing setting unit for acquiring an image processing setting value corresponding to the characteristics information of the reproducing apparatus acquired from the database. The digital image processor may additionally include a control unit for controlling the image captured by the digital image processor to be processed according to the acquired image processing setting value to obtain the optimal image and controlling the optimal image to be transmitted to the reproducing apparatus.

The reproducing apparatus may include a memory for storing the characteristics information of the reproducing apparatus about a manufacturer, type, and specifications thereof. The reproducing apparatus may also include a display unit for reproducing the optimal image received by the reproducing apparatus. The reproducing apparatus may additionally include a control unit for controlling the characteristics information of the reproducing apparatus stored in the memory to be transmitted to the digital image processor in response to a request of the digital image processor and controlling the optimal image received from the digital image processor to be displayed on the display unit.

The connection unit may include a high definition multimedia interface (HDMI) cable.

The digital image processor may control an operation of the reproducing apparatus via the connection unit.

The reproducing apparatus may control an operation of the digital image processor via the connection unit.

The digital image processor may further include an image pickup unit which inputs incident light from a subject and outputs an electrical signal corresponding to the captured image.

A system for capturing and reproducing an image may include a reproducing apparatus for storing characteristics information about a manufacturer, type, and specifications thereof of the reproducing apparatus, transmit the characteristics information in response to a request, and display a received image. The system may also include a digital image processor having a database which stores characteristics information of a variety of reproducing apparatuses and image processing setting values corresponding to the characteristics information of the variety of reproducing apparatuses. The digital image processor may be configured for processing an image captured by the digital image processor by acquiring an image processing setting value corresponding to the characteristics information of the reproducing apparatus from the database to obtain an optimal image. The digital image processor may be further configured for transmitting the optimal image to the reproducing apparatus for display. The system may additionally include a connection unit for transmitting and receiving data between the reproducing apparatuses and the digital image processor.

The connection unit may include an HDMI cable.

The digital image processor may further include an image pickup unit which inputs incident light from a subject and outputs an electrical signal corresponding to the captured image.

A method may be for operating a system for capturing and reproducing an image, the system including a digital image processor capturing an image, a reproducing apparatus for reproducing the image that is captured by the digital image processor, and a connection unit transmitting and receiving data between the digital image processor and the reproducing apparatus. The method may include acquiring characteristics information of the reproducing apparatus from the reproducing apparatus, processing the image captured by the digital image processor according to the characteristics information of the reproducing apparatus to obtain an optimal image, and transmitting the optimal image to the reproducing apparatus.

The acquiring of the characteristics information of the reproducing apparatus from the reproducing apparatus may include the digital image processor receiving the characteristics information about a manufacturer, type, and specifications of the reproducing apparatus from the reproducing apparatus.

The processing of the image may include acquiring an image processing setting value corresponding to the characteristics information of the reproducing apparatus from a database that stores characteristics information of a variety of reproducing apparatuses and image processing setting values corresponding to the characteristics information of the variety of reproducing apparatuses. The processing of the image may also include processing the image captured by the digital image processor according to the acquired image processing setting value to obtain the optimal image.

The method may further include acquiring an image processing setting value including at least one selected from the group consisting of gamma, noise, color, and brightness, and processing the image captured by the digital image processor according to the acquired image processing setting value to obtain the optimal image.

The processing of the image may include adjusting a color of the image.

The processing of the image may include adjusting a gamma of the image.

The processing of the image may include adjusting a contrast of the image.

The processing of the image may include adjusting a noise of the image.

The processing of the image may include adjusting a brightness of the image.

The method may further include displaying the optimal image using the reproducing apparatus.

### BRIEF DESCRIPTION OF THE DRAWINGS

The above and other features and advantages of the present invention will become more apparent by describing in detail exemplary embodiments thereof with reference to the attached drawings described below.

FIG. 1 is a block diagram of an exemplary digital image processor of a system for capturing and reproducing an image.

FIG. 2 is a block diagram of an exemplary system for capturing and reproducing an image including an embodiment of the digital signal processing unit of the digital image processor of FIG. 1.

FIG. 3 is a flowchart illustrating an exemplary method of operating a system for capturing and reproducing an image.

### DETAILED DESCRIPTION

Exemplary embodiments of the present invention will now be described more fully with reference to the accompanying drawings, in which exemplary embodiments of the invention are shown. The terminology used in the present specification and the appended claims should be construed broadly as referring to meanings and concepts matching the technical spirit of the present invention in order to describe embodiments of the present invention in the best fashion.

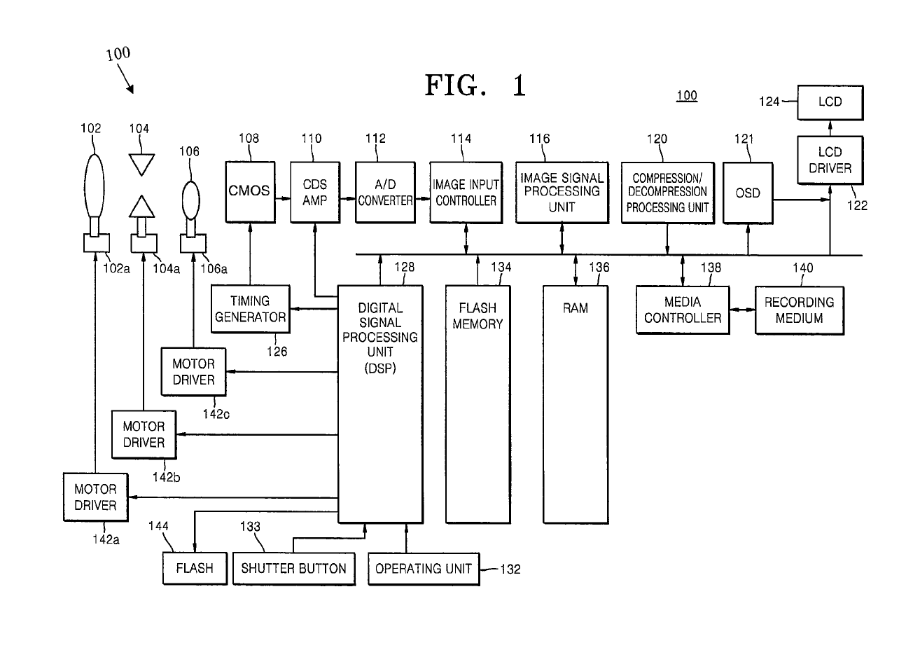

FIG. 1 is a block diagram of an exemplary digital image processor of a system for capturing and reproducing an image. The digital image processor 100 may include a zoom lens 102, an aperture 104, a focus lens 106, driving devices 102a, 104a, and 106a, a complementary metal oxide semiconductor (CMOS) device 108, a correlated double sampling (CDS) amplifier 110, an analogue-to-digital (A/D) converter 112, an image input controller 114, an image signal processing unit 116, a compression/decompression processing unit 120, an on-screen display (OSD) 121, a liquid crystal display (LCD) driver 122, an LCD 124, a timing generator 126, a digital signal processing (DSP) unit 128, an operating unit 132, a shutter button 133, a flash memory 134, a random access memory (RAM) 136, a media controller 138, a recording medium 140, motor drivers 142a, 142b, and 142c, and a flash 144. The RAM 136 may include a video random access memory (VRAM).

A focal length of the zoom lens 102 may be adjusted according to a desired size of a subject (e.g., an object) to be photographed by driving the zoom lens back and forth along an optical axis direction by the driving device 102a. During photographing, the aperture 104 may be driven by the driving device 104a to adjust an amount of light reaching the CMOS device 108. The focus lens 106 may be driven by the driving device 106a to bring the subject into focus by being moved back and forth in the optical axis direction.

Although only one zoom lens 102 and only one focus lens 106 are illustrated in FIG. 1, this depiction is not limiting and the number of zoom lenses may be two or more, and the number of focus lenses may also be two or more.

The CMOS device 108 may convert light incident from the zoom lens 102, the aperture 104, and the focus lens 106 into an electrical signal. The electrical signal may represent an image of the subject to be photographed. Although an electronic shutter may control incident light and adjust a time for acquiring the electrical signal in FIG. 1, in some embodiments a mechanical shutter may be used for the same purposes. An image pickup unit may include the zoom lens 102, the aperture 104, the focus lens 106, and the CDS amplifier 110. However, in some embodiments, the zoom lens 102 or the aperture 104 may be omitted.

The CMOS 108 may include a high speed CMOS image sensor. In this case, the digital image processor 100 may capture an image at 60 frames per second by using the high speed CMOS image sensor. The CDS amplifier 110 may include a combination of a CDS circuit, which may include a sampling circuit for subtracting noise from the electrical signal output from the CMOS device 108, and an amplifier for amplifying the electrical signal from which the noise is subtracted. Although the digital image processor 100 may include the CDS amplifier 110 in FIG. 1, this depiction is not limiting and in some embodiments the CDS circuit and the amplifier may be included as separate circuits.

The A/D converter 112 may convert the electrical signal amplified by the CDS amplifier 110 into a digital signal to generate raw data of the image. The image input controller 114 may control the raw data of the image generated by the A/D converter 112 to be input to the flash memory 134.

The image signal processing unit 116 may perform signal processing on the image, for example correcting an intensity gain or white balance in the electrical signal output from the CMOS device 108. The image signal processing unit 116 may acquire exposure data of the image. The exposure data may include an auto focus (AF) evaluation value and an auto exposure (AE) evaluation value. The image signal processing unit 116 may calculate the AF evaluation value and the AE evaluation value.

The compression/decompression processing unit 120 may compress the image processed by the image signal processing unit 116 into image data having a predetermined format. The predetermined format may include a JPEG format, for example.

The OSD 121 may display a set view image of the digital image processor 100 on the LCD 124. The LCD 124 may display a live view image before photographing, the set view image of the digital image processor 100, or the captured image. The image data or various information about the digital image processor 100 may be displayed on the LCD 124 via the LCD driver 122.

The timing generator 126 may input a timing signal to the CMOS device 108. A shutter speed may be determined by the timing signal input by the timing generator 126. For example, the operation of the CMOS device 108 may be controlled by the timing signal input by the timing generator 108, and light may be incident from the subject within a time during which the CMOS device 108 is driven, such that the electrical signal which is to be converted to the image data may be generated.

The DSP unit 128 may implement a command of a signal system with respect to the CMOS device 108 or the CDS amplifier 110, or implement a command of an operation system with respect to the operating unit 132.

The operating unit 132 may include elements for operating the digital image processor 100 and performing various set operations during photographing. The members may include a power button, a cross key, and/or a select button which may be pressed to select a photographing mode or a photographing drive mode (e.g., set a soft focus effect). When the shutter button 133 is pressed halfway, the focus lens 106 may automatically focus on the subject, and when the shutter button is pressed completely, an image of the subject may be captured.

The flash memory 134 may store a compressed booting program and an operating system. If the compressed booting program stored in the flash memory 134 is uploaded to the RAM 136 during booting, the DSP unit 128 may execute the compressed uploaded booting program uploaded to the RAM 136.

The captured image may be recorded on the recording medium 140, which may include an image recording unit. An input to and an output from the recording medium 140 may be controlled by the media controller 138. The recording medium 140 may include a memory card that records data.

The motor drivers 142a, 142b, and 142c may control the driving devices 102a, 104a, and 106a that drive the zoom lens 102, the aperture 104, and the focus lens 106, respectively. The zoom lens 102, the aperture 104, and the focus lens 106 may be driven by the motor drivers 142a, 142b, and 142c to adjust a size of the subject, the amount of light incident upon the CMOS device 108, and a focal point of the focus lens 106, respectively.

The flash 144 may be used to illuminate scenes including the subject that do not have enough light, for example, outdoors or dark places. During flashing, an illumination command may be input by the DSP unit 128 to the flash 144, and the flash 144 may emit light in response to the illumination command input by the DSP unit 128 to illuminate the subject.

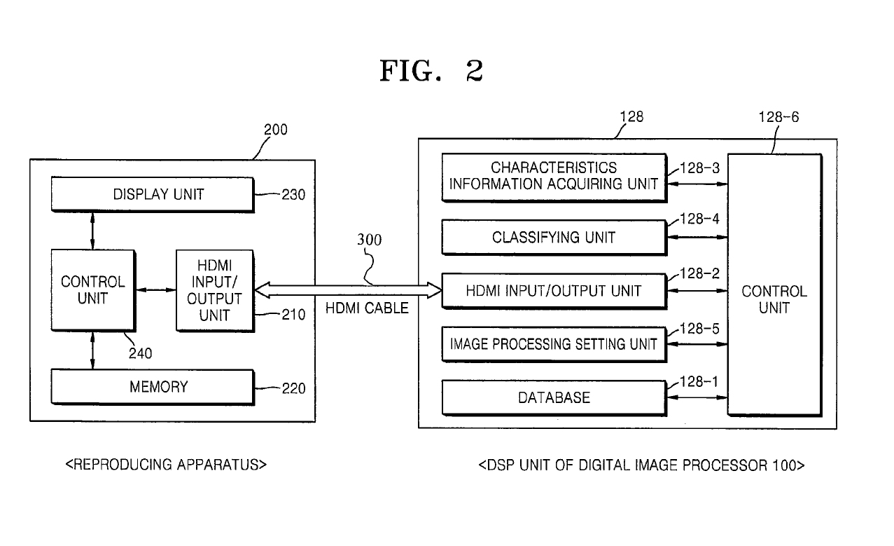

FIG. 2 is a block diagram of an exemplary system for capturing and reproducing an image including an embodiment of the digital signal processing unit of the digital image processor of FIG. 1. The exemplary system for capturing and reproducing an image illustrated in FIG. 2 includes the digital signal processing unit 128 of the digital image processor 100, a reproducing apparatus 200, and a high definition multimedia interface (HDMI) cable 300. The digital signal processing unit 128 of the digital image processor 100 may include a database 128-1, an HDMI input/output unit 128-2, a characteristics information acquiring unit 128-3, a classifying unit 128-4, an image processing setting unit 128-5, and a control unit 128-6. The reproducing apparatus 200 may include an HDMI input/output unit 210, a memory 220, a display unit 230, and a control unit 240.

The digital signal processing unit 128 of the digital image processor 100 will be explained first. The database 128-1 may store characteristics information of a variety of reproducing apparatuses which are acquired in advance. The database 128-1 may also store image processing setting values corresponding to the reproducing apparatuses information. The characteristics information of each of the variety of reproducing apparatuses stored in the database 128-1 may include information about a manufacturer, a type, and specifications thereof. For example, the reproducing apparatus may include a SAMSUNG television (TV) that may display images with high contrast and high noise. Also, the reproducing apparatus may include an LG TV that may display images with low contrast and low noise. In order to acquire such characteristics of reproducing apparatuses in advance and obtain the same image quality as that obtained by the digital image processor 100, the characteristics information may be stored in the database 128-1. The database 128 may also store image processing setting values, for example, gamma, noise, color, and brightness, in order to convert an image to an optimal image with high quality according to the previously acquired characteristics information.

The HDMI input/output unit 128-2 may receive characteristics information of the reproducing apparatus 200 from the reproducing apparatus 200. The HDMI input/output unit 128-2 may also transmit an image, which is received by the digital image processer 100, to the reproducing apparatus 200. The HDMI input/output unit 128-2 may communicate data between the digital image processor 100 and the reproducing apparatus 200. Since HDMI, which is an extension of a digital visual interface (DVI) for audio/video (AV) electronics, may transmit an audio/video signal from the digital image processor 100 to the reproducing apparatus 200 without compressing the audio/video signal, a decoder chip or software may not be necessary. Also, since the audio/video signal may be transmitted through one cable, AV equipment may be wired easily. Also, since a control signal may be sent, each piece of AV equipment may be used organically. Transition minimized differential signalling (TMDS) may be used for a physical layer data connection. High bandwidth digital content protection may be used to encode a signal. Extended display identification data (EDID) may be used for equipment authentication. Consumer electronics control (CEC) may be used for connection to a control system. Using the HDMI input/output unit 128-2, the digital image processer 100 may control the reproducing apparatus 200, and the reproducing apparatus 200 may also control the digital image processor 100. The reproducing apparatus 200 may be powered on or off.

The characteristics information acquiring unit 128-3 may acquire the characteristics information of the reproducing apparatus 200 received from the reproducing apparatus 200 through the HDMI input/output unit 128-2 from the characteristics information stored in the database 128-1. The characteristics information of the reproducing apparatus 200 may refer to information about the manufacturer, type, and specifications thereof.

The classifying unit 128-4 may classify the characteristics information of the reproducing apparatus 200 acquired by the characteristics information acquiring unit 128-3 into characteristics information about the type of the reproducing apparatus 200 and characteristics information about the manufacturer of the reproducing apparatus 200.

The image processing setting unit 128-5 may set an image processing operation that facilitates the reproducing apparatus 200 to display an optimal image. Since the database 128-1 may store the image processing setting values (e.g., gamma, noise, color, and brightness) necessary for converting an image into an optimal image with high quality according to the characteristics information that is acquired in advance, the image processing setting unit 128-5 may acquire an image processing setting value corresponding to the characteristics information of the reproducing apparatus 200 and use the extracted image processing setting value during the image processing operation. For example, if the reproducing apparatus 200 includes a SAMSUNG TV, the image processing setting value may be set to output a high contrast and low noise image. If the reproducing apparatus 200 includes an LG TV, the image processing setting value may be set to output a clear image.

The control unit 128-6 may control communication between the DSP unit 128 and the reproducing apparatus 200. The control unit 128-6 may also control the image signal processing unit 116 to output an image processing setting value, which facilitates the reproducing apparatus 200 to display an optimal image with high quality. The control unit 128-6 may transmit the optimal image to the reproducing apparatus 200 through the HDMI input/output unit 128-2.

The reproducing apparatus 200 will now be explained. The reproducing apparatus 200 may include any type of reproducing apparatus that can reproduce the image captured by the digital image processor 100.

The HDMI input/output unit 210 may transmit the characteristics information of the reproducing apparatus 200 in response to a request of the digital image processor 100. The HDMI input/output unit 210 may also receive the optimal image, which is suitable for the reproducing apparatus 200, from the digital image processor 100.

The memory 220 may store the characteristics information of the reproducing apparatus 200, that is, the information about the manufacturer, type, and specifications of the reproducing apparatus 200. The display unit 230 may display the optimal image received from the digital image processor 100.

The control unit 240 may control data communication between the digital image processor 100 and the reproducing apparatus 200. The control unit 240 may also control the characteristics information to be transmitted to the digital image processor 100 and the display unit 230 to display the optimal image received from the digital image processor 100.

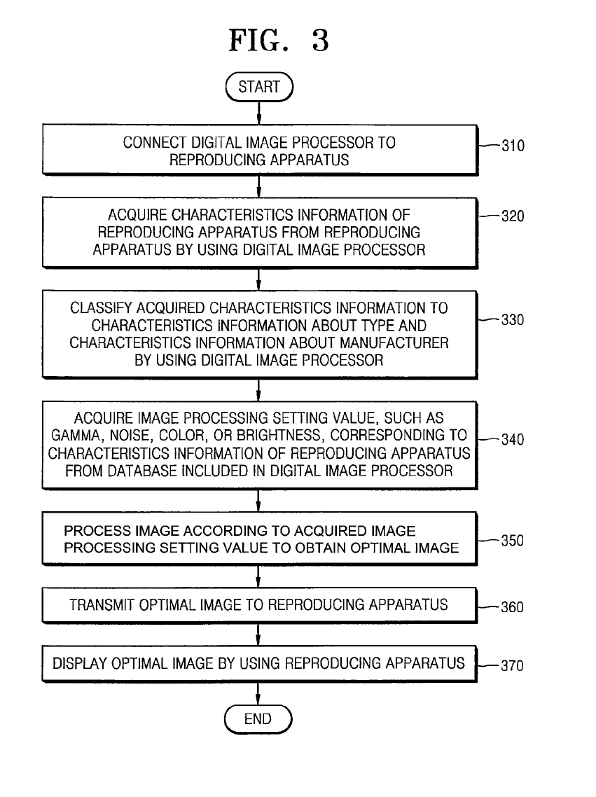

FIG. 3 is a flowchart illustrating an exemplary method of operating a system for capturing and reproducing an image.

In operation 310, the digital image processor 100 may be connected to the reproducing apparatus 200, for example via the HDMI cable 300. Since the HDMI cable 300 has already been described with reference to the HDMI input/output units 128-2 and 210 in FIGS. 1 and 2, a detailed explanation thereof will not be repeated.

In operation 320, the digital image processor 100 may acquire characteristics information of the reproducing apparatus 200 from the reproducing apparatus 200. For example, once the digital image processor 100 transmits a request signal through the HDMI cable 300, the reproducing apparatus 200 may receive the request signal and transmit the characteristics information stored therein to the digital image processor 100 through the HDMI cable 300.

In operation 330, the digital image processor 100 may classify the acquired characteristics information of the reproducing apparatus 200 into characteristics information about the type of the reproducing apparatus 200 and characteristics information about the manufacturer of the reproducing apparatus 200. The digital image processor 100 may include the database 128-1 that stores characteristics information of a variety of reproducing apparatuses which are acquired in advance, and image processing setting values, such as gamma, noise, color, and brightness, necessary for converting an image to an optimal image with high quality according to the characteristics information as described above. The digital image processor 100 may classify the characteristics information of the reproducing apparatus 200 into the characteristics information about the type of the reproducing apparatus 200 and the characteristics information about the manufacturer of the reproducing apparatus 200 from the characteristics information of the variety of reproducing apparatuses which are stored in the database 128-1 in advance.

In operation 340, the digital image processor 100 may acquire an image processing setting value corresponding to the characteristics information of the reproducing apparatus 200 from the database 128-1.

In operation 350, the digital image processor 100 may process the image according to the acquired image processing setting value to obtain an optimal image. For example, if the reproducing apparatus 200 includes a SAMSUNG TV, the digital image processor 100 may process the image to output an optimal image, e.g., a high contrast and low noise image, by using the image processing setting value. If the reproducing apparatus 200 is an LG TV, the digital image processor 100 may process the image to output an optimal image, e.g., a clear image, by using the image processing setting value.

In operation 360, the digital image processor 100 may transmit the optimal image to the reproducing apparatus 200, for example through the HDMI cable 300.

In operation 370, the reproducing apparatus 200 may receive the optimal image from the digital image processor 100 and display the optimal image.

As described above, since the digital image processor 100 may acquire characteristics information of the reproducing apparatus 200, process an image according to the characteristics information of the reproducing apparatus 200 to obtain an optimal image, and transmit the optimal image to the reproducing apparatus 200, the reproducing apparatus 200 may display the optimal image.

A program for executing a method of reproducing an image using the system for capturing and reproducing an image according to the aforementioned embodiments or modifications thereof may be stored in a computer-readable storage medium. The storage medium may include the recording medium 140 and/or the flash memory 134, as illustrated in FIG. 1. Examples of the storage medium include magnetic storage media (e.g., floppy disks or hard disks), optical recording media (e.g., CD-ROMs or digital versatile disks (DVDs)), and electronic storage media (e.g., integrated circuits (IC's), ROM, RAM, or flash memory).

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated. It will be recognized that the terms “comprising,” “including,” and “having,” as used herein, are specifically intended to be read as open-ended terms of art.

What is claimed is:

1. A system for capturing and reproducing an image, the system comprising:
a digital image processor for capturing an image;
a reproducing apparatus for reproducing the image captured by the digital image processor; and
a connection unit for transmitting and receiving data between the digital image processor and the reproducing apparatus,
wherein the digital image processor processes the image captured by the digital image processor according to characteristics information of the reproducing apparatus to obtain an optimal image and transmits the optimal image to the reproducing apparatus.

2. The system of claim 1, wherein the digital image processor comprises:
a database for storing characteristics information of a variety of reproducing apparatuses and image processing setting values corresponding to the characteristics information of the variety of reproducing apparatuses;
a characteristics information acquiring unit for acquiring the characteristics information of the reproducing apparatuses from the database;
an image processing setting unit for acquiring an image processing setting value corresponding to the characteristics information of the reproducing apparatus acquired from the database; and
a control unit for controlling the image captured by the digital image processor to be processed according to the acquired image processing setting value to obtain the optimal image and controlling the optimal image to be transmitted to the reproducing apparatus.

3. The system of claim 1, wherein the reproducing apparatus comprises:
a memory for storing the characteristics information of the reproducing apparatus about a manufacturer, type, and specifications thereof;
a display unit for reproducing the optimal image received by the reproducing apparatus; and
a control unit for controlling the characteristics information of the reproducing apparatus stored in the memory to be transmitted to the digital image processor in response to a request of the digital image processor and controlling the optimal image received from the digital image processor to be displayed on the display unit.

4. The system of claim 1, wherein the connection unit includes a high definition multimedia interface (HDMI) cable.

5. The system of claim 1, wherein the digital image processor controls an operation of the reproducing apparatus via the connection unit.

6. The system of claim 1, wherein the reproducing apparatus controls an operation of the digital image processor via the connection unit.

7. The system of claim 1, wherein the digital image processor further comprises an image pickup unit which inputs incident light from a subject and outputs an electrical signal corresponding to the captured image.

8. A system for capturing and reproducing an image, the system comprising:
a reproducing apparatus which stores characteristics information about a manufacturer, type, and specifications thereof of the reproducing apparatus, transmits the characteristics information in response to a request, and displays a received image;
a digital image processor comprising a database which stores characteristics information of a variety of reproducing apparatuses and image processing setting values corresponding to the characteristics information of the variety of reproducing apparatuses, the digital image processor being configured for processing an image captured by the digital image processor by using an image processing setting value corresponding to the characteristics information of the reproducing apparatus from the database to obtain an optimal image, and being further configured for transmitting the optimal image to the reproducing apparatus for display; and
a connection unit for transmitting and receiving data between the reproducing apparatus and the digital image processor.

9. The system of claim 8, wherein the connection unit includes an HDMI cable.

10. The system of claim 8, wherein the digital image processor further comprises an image pickup unit which inputs incident light from a subject and outputs an electrical signal corresponding to the captured image.

11. A method of operating a system for capturing and reproducing an image, the system comprising a digital image processor for capturing an image, a reproducing apparatus for reproducing the image that is captured by the digital image processor, and a connection unit for transmitting and receiving data between the digital image processor and the reproducing apparatus, the method comprising:
acquiring characteristics information of the reproducing apparatus from the reproducing apparatus;
processing the image captured by the digital image processor according to the characteristics information of the reproducing apparatus to obtain an optimal image; and
transmitting the optimal image to the reproducing apparatus.

12. The method of claim 11, wherein the acquiring of the characteristics information of the reproducing apparatus from the reproducing apparatus comprises the digital image processor receiving the characteristics information about a manufacturer, type, and specifications of the reproducing apparatus from the reproducing apparatus.

13. The method of claim 11, wherein the processing of the image comprises:
acquiring an image processing setting value corresponding to the characteristics information of the reproducing apparatus from a database that stores characteristics information of a variety of reproducing apparatuses and image processing setting values corresponding to the characteristics information of the variety of reproducing apparatuses; and
processing the image captured by the digital image processor according to the acquired image processing setting value to obtain the optimal image.

14. The method of claim 11, further comprising:
acquiring an image processing setting value including at least one selected from the group consisting of gamma, noise, color, and brightness; and
processing the image captured by the digital image processor according to the acquired image processing setting value to obtain the optimal image.

15. The method of claim 11, wherein the processing of the image includes adjusting a color of the image.

16. The method of claim 11, wherein the processing of the image includes adjusting a gamma of the image.

17. The method of claim 11, wherein the processing of the image includes adjusting a contrast of the image.

18. The method of claim 11, wherein the processing of the image includes adjusting a noise of the image.

19. The method of claim 11, wherein the processing of the image includes adjusting a brightness of the image.

20. The method of claim 11, further comprising displaying the optimal image using the reproducing apparatus.
